(19) United States
(12) Patent Application Publication
(10) Pub. No.: US 2006/0154010 A1
(43) Pub. Date: Jul. 13, 2006

(54) FLUORINE RESIN TUBULAR ARTICLE, FIXING ROLL, FIXING BELT AND IMAGE FIXING APPARATUS

(76) Inventor: Shinro Oyama, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/562,447

(22) PCT Filed: Jul. 2, 2004
(86) PCT No.: PCT/JP04/09783

§ 371 Date: Dec. 27, 2005

(30) Foreign Application Priority Data
Jul. 2, 2003 (JP) 2003-190671

(51) Int. Cl. B29C 47/00; B32B 27/00; G03G 15/20

(52) U.S. Cl. 428/36.9; 428/220; 428/36.91; 428/421; 399/333

(57) ABSTRACT

The present invention is tubular article comprising a polytetrafluoroethylene-based fluorine resin as a constitutional element, wherein the article has a maximum wall thickness of 20 μm or smaller, and satisfies the following (1) and/or (2) properties.
(1) Tensile elastic moduli in a circumferential direction and a tube axial direction are both 900 N/mm² or more.
(2) Tensile stresses at 5% elongation in a circumferential direction and a tube axial direction are both N/mm² or greater. When this fluorine resin tubular article is used as a superficial layer of a fixing roll or a fixing belt, excellent durability can be exerted.

### TECHNICAL FIELD

The present invention relates to a fluorine resin tubular article (fluororesin tubular article) which is suitable as a member of an image fixing apparatus, a fixing roll and a fixing belt using the fluorine resin tubular article, and an image fixing apparatus having these fixing roll and fixing belt.

### BACKGROUND ART

In an image fixing apparatus such as an electrophotographic copying machine and a laser beam printer, an image is formed through an electrification step of uniformly electrifying a photosensitive drum, a light exposing step of forming an electrostatic latent image on the photosensitive drum, a development step of visualizing the electrostatic latent image with a toner, a transference step of transferring the toner on the photosensitive drum onto a material to be transferred, a fixation step of fixing the material to be transferred and a toner, and a cleaning step of cleaning the toner remaining on the photosensitive drum after the transference step.

In recent years, in an electrophotographic image fixing apparatus, from a view point of effective utilization of resources, improvement instability in an apparatus, securement of high reliability, and reduction in the running cost are required. As one strategy therefor, omission of supply of a releasing oil to a surface of a fixing member such as a fixing roll and a fixing belt by use of a wax toner has been studied. However, there is a problem that, when supply of the releasing oil is stopped, progression of abrasion of a superficial layer of a fixing member due to abutment of a paper edge or a temperature sensor is accelerated. In addition, with speed up of a copying machine and a laser printer, a load on a fixing member is increased and, also for this reason, securement of a fixing member life has become difficult.

In particular, in a soft roll used in color image fixation (fixing roll), the effect of a releasing agent (releasing oil) on abrasion is remarkable; when a releasing agent is not supplied, a scratch or abrasion occurs in some cases after printing a few hundreds of sheets, on a superficial layer of a soft roll formed of a silicone rubber or a fluorine rubber. For this reason, as described in Japanese Patent Application Publication (JP-B) No. 58-43740 and Electrophotography Bulletin, Year Heisei 6, vol. 33, No. 1, P. 57-65, a fixing member in which an outermost layer of a roll formed of a silicone rubber elastic body around a core metal is covered with a tetrafluoroethylene-perfluoroalkyl vinyl ether copolymer (PFA) tube as a releasing layer having abrasion resistance, is proposed.

Meanwhile, in order to obtain a color fixed image of high quality, it is important that a surface of a fixing roll follows irregularities of a surface of a recording paper, and uniformly contacts a whole unfixed toner image. Unless a surface of a fixing roll uniformly contacts a whole unfixed toner image, a melting-degree of toner forming unfixed toner image becomes uneven, and uneven brightness of a fixed image occurs, leading to reduction in image quality. A fluorine resin such as PFA fits to irregularities of a surface of a recording paper with difficulty because an elastic modulus is higher, and creating distortion is difficult as compared with a silicone rubber and a fluorine rubber. Then, when an outermost layer is comprised of a fluorine resin, it is important to make the outermost layer as thin as possible, allowing a roll surface to easily follow irregularities of a surface of a recording paper.

In addition, in order to perform image fixation of a color image at a high speed, and suppress a consumed electric power low, it is preferable to reduce a heat capacity of a roll and, additionally, good heat conductivity is required. Also from such a point of view, it is desirable that a fluorine resin layer as an outermost layer is as thin as possible.

On the other hand, as an image fixing apparatus, there is a belt-type fixing apparatus using a fixing belt instead of the aforementioned fixing roll for achieving a relatively long fixing nip portion. This fixing belt is generally such that a releasing layer is formed on a belt consisting of a thin metal or a heat-resistant resin such as polyimide and, also in this case, it is preferable that a heat capacity of a belt is small, and good heat conductivity is required. For this reason, also when a fluorine resin layer as a releasing layer is formed on such a fixing belt, it becomes important that the fluorine resin layer is as thin as possible.

As a fluorine resin tube generally used as a superficial layer of a fixing roll or a fixing belt, the tube consisting of PFA is known as described above. Since PFA can be molded by melting, a tube consisting of PFA also has relatively better moldability, and can be reduced to around 30 μm in a tube thickness. However, it is difficult to form the tube with a thickness of 20 μm or smaller. In addition, a tensile strength of a PFA tube manufactured by melting molding is small, particularly in a circumferential direction.

For this reason, when a PFA tube having a wall thickness of 20 μm is manufactured experimentally, a wall thickness become thinner than aimed wall thickness in some cases. In these cases, even slight load generates deformation or breakage of the tube. And such the circumstances, handling of the aforementioned experimentally manufactured PFA tube upon procession into, for example, a superficial layer of a fixing roll is extremely difficult. In addition, when such a PFA tube is used as a superficial layer of a soft roll-type fixing roll, the PFA tube itself is plastically deformed due to deformation of a fixing roll surface at a nip portion formed between a fixing roll and another fixing member. There is a problem that this plastic deformation generates a wrinkle of a superficial layer of a fixing roll, and this wrinkle trace appears on a fixed image. Further, when this PFA tube is used as a superficial layer of a fixing roll, a paper jam easily occurs at a fixing nip portion. There is a problem that, when a paper jam occurs at a fixing nip portion, since fracture occurs in a jammed paper, and a load is concentrated in this fractured portion, deformation or breakage easily occurs at a superficial layer of a PFA tube of a fixing roll surface contacting with a fracture portion.

For further higher image quality, and energy saving, a fluorine resin releasing layer (superficial layer) having a thickness of 20 μm or less is desired, and among such thin fluorine resin tubes, there was no tube having a sufficient strength as a fixing roll superficial layer.

Such being the circumstances, the present inventors progressed development of a fluorine resin tube using polytetrafluoroethylene (PTFE). Since PTFE has extremely excellent heat resistance and releasability, it is a suitable material in a most superficial layer of the aforementioned fixing roll and fixing belt.

PTFE has a high melt viscosity, and cannot be subjected to melt extrusion molding as in a general thermoplastic resin. For this reason, usually, PTFE is molded by a so-called paste extrusion method, in which a paste-like blend obtained by uniformly kneading a PTFE powder and a liquid lubricant such as naphtha and xylene is extruded in a tube, and the liquid lubricant is removed by extraction or drying. However, in the case of this paste extrusion method, when one tries to reduce a wall thickness of a tube, since an extrusion pressure is increased, a variability in a thickness (unevenness of thickness) occurs, and appearance is deteriorated, there is a limitation on reduction in a wall thickness. In particular, in a tube having an outer diameter of φ10 mm or greater, it is extremely difficult to reduce a tube wall thickness to 20 μm or smaller.

Besides, as a process for manufacturing a fluorine resin tube, for example, Japanese Patent Application Laid-Open (JP-A) No. 50-136367 discloses a process for manufacturing a thin-walled fluorine resin tube, comprising coating a fluorine resin paint on a metal wire body, and baking this to form a film, thereafter, stretching this film wire body at least until a fluorine resin film loses adherability to the wire body, and drawing the metal wire. However, in this process, there is a problem that uniformity in a wall thickness is hardly obtained, abrasion resistance and strength of the resulting tube are remarkably low, and smoothness of a surface is insufficient.

In addition, JP-A No. 4-296332 discloses a thin-walled fluorine resin tube, comprising modified PTFE containing 0.02 to 0.4% by weight of perfluoroalkyl vinyl ethyl or hexafluoropropylene, wherein a value obtained by dividing an internal diameter dimension by a wall thickness dimension is 300 or more. However, also in this method, there is a problem that, as a wall thickness grows smaller, occurrence of a pinhole and reduction in a strength are remarkable, it is substantially difficult to obtain a tube having a wall thickness of 20 μm or smaller, it is difficult to manufacture a tube having a relatively large aperture diameter (e.g. internal diameter is 60 mm or more), and modification of PTFE deteriorates heat resistance.

On the other hand, the present inventors developed a thin-walled fluorine resin tubular article characterized in that extremely thin PTFE films are wound, laminated, and adhered, and already filed a patent application (Japanese Patent Application No. 2002-191221). In this fluorine resin tubular article, a pinhole is not generated, a wall thickness can be reduced to 20 μm or smaller, and a tensile strength can be 80 N/mm² or more in both tube circumferential and axial directions. Therefore, the article can be suitably used as a most superficial layer of a fixing roll and a fixing belt of an image fixing apparatus.

By the aforementioned fluorine resin tubular article developed by the present inventors, suppression of a superficial layer wrinkle, superficial layer deformation, and superficial layer breakage which have been occurred in a superficial layer consisting of the aforementioned experimentally manufactured PFA tube having a wall thickness of around 20 μm could be accomplished. However, even in this fluorine resin tubular article, when an image fixing apparatus is operated for a long period of time, for example, the aforementioned problem arisen in a superficial layer consisting of the aforementioned PFA tube arises in some cases, and in this respect, there remains room for improvement.

The present invention was done in view of the aforementioned circumstances, and the purpose thereof is to provide a fluorine resin tubular article which can exert excellent durability when used as a superficial layer of a fixing roll or a fixing belt, a fixing roll and a fixing belt using the fluorine resin tubular article, and an image fixing apparatus having the fixing roll or the fixing belt.

### DISCLOSURE OF THE INVENTION

A fluorine resin tubular article of the present invention which can attain the aforementioned purpose is a tubular article comprising a polytetrafluoroethylene-based fluorine resin as a constitutional element, and has a maximum wall thickness of 20 μm or smaller. And, the fluorine resin tubular article of the present invention satisfies the following (1) and/or (2) properties:

(1) Tensile elastic moduli in a circumferential direction and a tube axial direction are both 900 N/mm² or greater.

(2) Tensile stresses at 5% elongation in a circumferential direction and a tube axial direction are both 15 N/mm² or greater.

The fluorine resin tubular article having both tensile elastic moduli in a circumferential direction and a tube axial direction (1) of 900 N/mm² or greater, can be formed by winding and laminating a fluorine resin thin film having a tensile elastic modulus of 500 N/mm² or greater in any plane direction two or more times. In addition, the fluorine resin tubular article having tensile stresses at 5% elongation in a circumferential direction and a tube axial direction, both being 15 N/mm² or greater, can be formed by winding and laminating a fluorine resin thin film having a tensile stress at 5% elongation of 20 N/mm² or greater in any plane direction, two or more times.

Further, it is desirable that the fluorine resin tubular article of the present invention has surface roughness (Ra) of 0.5 μm or less. In addition, the tubular article is preferably such that an inner surface has been surface-treated in order to improve adherability.

In addition, a fixing roll and a fixing belt having the aforementioned each fluorine resin tubular article in a superficial layer, and an image fixing apparatus having the fixing roll or the fixing belt are also included in the present invention.

Hereinafter, unless otherwise indicated, a polytetrafluoroethylene-based fluorine resin is simply referred to as “fluorine resin”.

In addition, as used herein, “surface roughness (Ra)” means Ra (arithmetic average roughness) determined according to the provision of JIS B 0601 in all cases.

### BRIEF DESCRIPTION OF THE DRAWINGS

FIG. 1 is a schematic view for explaining the method of spirally winding an obi-like fluorine resin thin film around a core metal.

### BEST MODE FOR CARRYING OUT THE INVENTION

The present inventors continued to study in order to suppress superficial layer wrinkle, superficial layer deformation, and superficial layer breakage which can occur when a fixing roll having a fluorine resin tubular article previously developed by the present inventors and relating to Japanese Patent Application No. 2002-191221 in its superficial layer is used in an image fixing apparatus, and the fixing roll is operated for a long period of time. As a result, the present inventors found out that enhancement of particular nature in a circumferential direction and a tube axial direction of a fluorine resin tubular article lead to attainment of the above purpose, and completed the present invention.

The fluorine resin tubular article of the present invention has a maximum wall thickness of 20 μm or smaller, and satisfies the following (1) and/or (2) properties.

(1) Tensile elastic moduli in a circumferential direction and a tube axial direction are both 900 N/mm² or greater (hereinafter referred to as “property 1”).

(2) Tensile stresses at 5% elongation in a circumferential direction and a tube axial direction (hereinafter referred to as “5% tensile stress”) are both 15 N/mm² or greater (hereinafter, referred to as “property 2”).

In the present invention, it is enough that either of the property 1 (tensile elastic modulus) and property 2 (5% tensile stress) is satisfied, and it is preferable that both properties are satisfied.

As used herein, a tensile elastic modulus, a 5% tensile stress, and a tensile strength (described later) are values obtained by performing a tensile test employing “RTC-1210A” manufactured by ORIENTEC Co., LTD. using a strip of test piece (width: 10 mm) under the conditions of a distance between chucks: 50 mm, and a test speed: 100 mm/min. When a tensile test of a fluorine resin tubular article is performed, the tubular article is cut open to make a test piece.

A tensile elastic modulus Em (N/mm²) is a value obtained using the following equation based on an initial straight part risen from an initial load point of a tensile stress-strain curve obtained upon a tensile test.
Em=Δσ/Δε

[Δσ: a difference in stresses based on original (before tension) average cross-sectional area between two points on the straight line, Δε: a difference in strains between the same two points]

A 5% tensile stress is the stress in a point elongated, by 5% of a distance between chucks (50 mm), based on an initial load point of a tensile stress-strain curve obtained upon the tensile test, and the stress is based on original (before tension) average cross-sectional area.

If the tensile elastic modulus in the tube axial direction is below the aforementioned lower limit value and the 5% tensile stress in the tube axial direction is below the aforementioned lower limit value, since when this fluorine resin tubular article is used in a superficial layer of a fixing roll or a fixing belt, the superficial layer is stretched in an axial direction with introduction of paper, a superficial layer wrinkle easily occurs in a circumferential direction. Similarly, if the tensile elastic modulus in the circumferential direction is below the aforementioned lower limit value, and the 5% tensile stress in the circumferential direction is below the aforementioned lower limit value, since when this fluorine resin tubular article is used in a fixing roll or a fixing belt, the superficial layer is stretched in a circumferential direction with introduction of a paper, a superficial layer wrinkle easily occurs in a tube axial direction. Therefore, when an attention is paid to the tensile elastic modulus, tensile elastic moduli in a circumferential direction and a tube axial direction are both preferably 900 N/mm² or greater, more preferably 1000 N/mm² or greater. In addition, when an attention is paid to the 5% tensile stress, 5% tensile strengths in a circumferential direction and a tube axial direction are both preferably 15 N/mm² or greater, more preferably 20 N/mm² or greater.

A thickness of the fluorine resin tubular article in terms of a maximum wall thickness is 20 μm or smaller, preferably 15 μm or smaller, further preferably 10 μm or smaller. As described above, in the fluorine resin tubular article used in a superficial layer of a fixing roll and a fixing belt, a thinner wall thickness is required. When the fluorine resin tubular article is used in a superficial layer of a fixing roll or a fixing belt, if the thickness of the article is too great, it becomes difficult to fit to irregularities of a surface of a recording paper, and a heat capacity is increased.

On the other hand, when the thickness of the fluorine resin tubular article is too small, a strength as a superficial layer becomes insufficient, and handling property at manufacturing of the fluorine resin tubular article and at manufacturing of a fixing roll or a fixing belt is deteriorated. Therefore, a thickness of a fluorine resin tubular article in terms of a maximum wall thickness is preferably 2 μm or greater, more preferably 4 μm, further preferably 5 μm.

In the fluorine resin tubular article of the present invention, a surface roughness (Ra) is preferably 0.5 μm or lower, more preferably 0.4 μm or lower, further preferably 0.3 μm or lower. Releasability of a toner at printing can be enhanced, and a unevenness of press of a toner on a paper can be minimized by adopting such the surface roughness, and therefore image quality of a printed image can be enhanced.

The fluorine resin tubular article is formed by winding and laminating a fluorine resin thin film two or more times.

In order to obtain the fluorine resin tubular article satisfying property 1 (tensile elastic modulus), the aforementioned fluorine resin thin film having a tensile elastic modulus of 500 N/mm² or greater, more preferably 700 N/mm² or greater in any plane direction may be used.

In addition, the fluorine resin tubular article satisfying property 2 (5% tensile stress) can be obtained by using the aforementioned fluorine resin thin film having a 5% tensile stress of 20 N/mm² or greater, more preferably 30 N/mm² or greater in any plane direction.

The fluorine resin thin film having the aforementioned tensile elastic modulus or 5% tensile stress can be obtained, for example, as follows:

Examples of a fluorine resin used in a fluorine resin thin film include a polytetrafluoroethylene (PTFE)-based fluorine resin. By using a PTFE-based fluorine resin, the fluorine resin thin film excellent in abrasion resistance, heat resistance and releasability in addition to the tensile elastic modulus and the 5% tensile stress can be obtained.

Representative examples of the PTFE-based fluorine resin include PTFE (polymer of tetrafluoroethylene) and, as far as the fluorine resin thin film can achieve the aforementioned tensile elastic modulus or 5% tensile stress, a copolymer in which a monomer other than tetrafluoroethylene is copolymerized, or a blend in which other fluorine resin is mixed into PTFE may be used.

Examples of the monomer other than tetrafluoroethylene, when the PTFE-based fluorine resin partially has a copolymerization component, include an ethylenic-based unsaturated monomer such as ethylene, chlorotrifluoroethylene, vinyl fluoride, vinylidene fluoride, hexafluoropropylene, and perfluoroalkyl vinyl ether.

In addition, examples of the fluorine resin that can be mixed with PTFE include tetrafluoroethylene-hexafluonepropylene copolymer (FEP), ethylene-tetrafluoroethylene copolymer (ETFE), tetrafluoroethylene-perfluoroalkyl vinyl ether copolymer (PFA), polychlorotrifluoroethylene (PCTFE), polyvinylidene fluoride (PVDF), and polyvinyl fluoride (PVF).

Hereinafter, by taking a particularly preferable example, PTFE, among PTFE-based fluorine resins, a process for manufacturing the fluorine resin thin film will be explained. In addition, also when the PTFE-based fluorine resin is the aforementioned copolymer or blend, a following procedure can be adopted.

As a method of obtaining a fluorine resin thin film (hereinafter, referred to as “PTFE thin film”) containing PTFE as a constitutional material, a so-called skiving method of thinly skiving a bar material of PTFE is general, and in this method, it is difficult to obtain a thin film having a thickness of 20 μm or smaller. In addition, it is not easy to control a tensile elastic modulus and a 5% tensile stress at the aforementioned lower limit value or more.

As a method of forming a PTFE thin film having the aforementioned property values, for example, a method of closing a pore by subjecting an expanded porous PTFE film to thermal press, to obtain a structure having an extremely small porosity or substantially containing no pore can be adopted.

Herein, the expanded porous PTFE film is obtained by molding a paste of a mixture of a fine powder of PTFE (crystallinity degree 90% or more) and a molding aid, removing the molding aid from the resulted molded body, expanding this at a high temperature [a temperature lower than a melting point (about 327° C.) of PTFE, for example, about 300° C.] and a high speed and, if necessary, baking this.

Upon expanding, when the film is expanded only in a monoaxial direction of the MD (longitudinal direction at manufacturing of the expanded porous PTFE film) or the TD (direction orthogonal with MD), a monoaxially expanded porous PTFE film is obtained, and when the film is expanded in a biaxial direction of the MD and the TD, a biaxially expanded porous PTFE film is obtained.

In the monoaxially porous PTFE film, nodes (folded crystals) form thin islands orthogonal with a expanding direction, and fibrils (i.e. straight chain molecular bundle obtained by dissociation and pull-out of the folded crystal by expanding) is oriented in a expanding direction in a bamboo blind manner, spanning between nodes. And, a fibrous structure is formed in which a space defined between fibrils, or defined by a fibril and a node becomes a pore. In addition, in a biaxially expanded porous PTFE film, fibrils are expanded radially, nodes spanning the fibrils are scattered in an island manner, and spider web fibrous structures are formed, in which there are many spaces defined by fibrils and nodes.

In the aforementioned PTFE thin film, the biaxially expanded porous PTFE film is used as a raw material. The biaxially expanded porous PTFE film, since the film is expanded in two axial directions (MD and TD), has smaller anisotropy than the monoaxially expanded film, and can maintain excellent properties (e.g. strength) in both the MD and the TD. In the monoaxially expanded film, it is difficult to realize a tensile elastic modulus and a tensile stress at 5% elongation in the TD having the aforementioned value required in a fluorine resin thin film, or more.

In the expanded porous PTFE film, a porosity thereof is preferably 5 to 95%, more preferably 40 to 90%. The porosity is a value obtained from an apparent density p (g/cm³) of an expanded porous PTFE film, and a density (2.2 g/cm³) of PTFE constituting the film which are measured according to the provision of JIS K 6885, using the following equation:
porosity (%)=100×(2.2−ρ)/2.2.

In addition, a preferable thickness of the expanded porous PTFE film varies depending on a desired thickness of the PTFE thin film and a porosity of the expanded porous PTFE film and, for example, is preferably 3 to 500 μm, more preferably 5 to 200 μm. A thickness of the expanded porous PTFE film or the fluorine resin thin film (PTFE thin film) referred to in this specification is an average thickness (a value measured in the state where a load other than a base spring load is not applied) measured with a dial gauge (e.g. 1/1000 mm dial thickness gauge manufactured by TECHNOLOCK) (same hereinafter).

A tensile elastic modulus and a 5% tensile stress of a PTFE thin film can be controlled by adjusting an expansion ratio and baking condition at manufacturing of the expanded porous PTFE film. In order to secure these property values in the PTFE thin film, it is recommended that a expanding ratio is 900 to 5000%, more preferably 2500 to 5000% in both of the MD and the TD, and a baking temperature is 370 to 385° C., more preferably 375 to 380° C. A baking time is different depending on a baking temperature, and it is recommended that, for example, a baking time is 15 to 30 minutes at 370° C., and a baking time is 3 to 5 minutes at 385° C. The expanding ratio is a value considered a length of a PTFE molded body before expanding to be 100%.

Upon manufacturing of the PTFE thin film from the expanded porous PTFE film, first, the expanded porous PTFE film is compressed (pressed) at a temperature lower than the melting point thereof to obtain a rolled film (first compressing step). The compressing temperature in this case is not particularly limited as far as it is lower than the melting point of PTFE, but is usually a temperature lower by 1° C. or more, more preferably a temperature lower by 100° C. or more. When the compressing temperature is equal to or higher than the melting point of PTFE, shrinkage of the PTFE thin film becomes great, being not preferable.

Compressing condition in the first compressing step is the condition under which a porosity of a rolled film after the step is 50% or less, more preferably 20% or less, further preferably 10% or less of that of the expanded porous PTFE film before compression. A compressing force in terms of a surface pressure is 0.5 to 60 N/mm², more preferably 1 to 50 N/mm². A compressing apparatus used in this step is not particularly limited as far as it is an apparatus which can compress a film, but apparatus that compresses by passage of a film between rolls or between belts such as a calendar roll apparatus and a belt press apparatus is preferable. Upon use of such the apparatus, since when the expanded porous PTFE film is held between rolls or between belts, the air present in the interior of the film or between layers of the film is easily pushed out to the outside, occurrence of a void (e.g. a void that can be confirmed when a surface is observed using a scanning electron microscope at a magnification of 2000×) and a wrinkle in the resulting PTFE thin film can be minimized.

Then, the rolled film obtained in a first compressing step is compressed (pressed) at a temperature not lower than the melting point of PTFE (second compressing step). The compressing temperature in this case is not particularly limited as far as it is a temperature not lower than the melting point of PTFE, but is usually a temperature higher by 1 to 100° C., more preferably a temperature higher by 20 to 80° C. By adopting such a temperature, surface smoothness of the PTFE thin film can be enhanced. In addition, it is desirable that the compressing temperature is cooled to a temperature lower than the melting point of PTFE at release of a pressure. Since when a pressure is released at the temperature not lower than the melting point of PTFE, shrinkage of the PTFE thin film grows larger, and additionally, wrinkle is easily formed, this is not preferable.

Compressing condition in the second compressing step is preferably the condition under which a porosity of the resulting fluorine resin thin film is 5% or less, more preferably 1% or less. Specifically, a compressing force in terms of a surface pressure is generally 0.01 to 50 N/mm², more preferably 0.1 to 40 N/mm². A compressing apparatus used in this step is not particularly limited as far as it can compress the film while holding it in between, but a hot press apparatus and a belt press apparatus which can heat and press for a certain time are preferable.

In addition, when the fluorine resin thin film used in the fluorine resin tubular article of the present invention is manufactured by such the procedure, a few pores may remain, as far as the pores do not become problematic in properties in the fluorine resin tubular article which is a final product. Specifically, as described above, it is not a problem that 5% or less, preferably 1% or less of pores remain. A fluorine resin thin film having a porosity of 0% is most preferable.

In addition, when an apparatus which can cool a film to a temperature not higher than the melting point of PTFE in the state where a pressure is retained after a temperature not lower than the melting point of PTFE is applied while the expanded porous PTFE film is compressed is used, the PTFE thin film can be obtained by one pass. According to this method, since even when the temperature not lower than the melting point of PTFE is applied to the expanded porous PTFE film from a compression initiating time, the film can be cooled to the temperature lower than the melting point of PTFE before the pressure applied to the expanded porous PTFE film is released, shrinkage scarcely occurs in the manufactured PTFE thin film. For example, when a belt press apparatus is used, by cooling a film to the temperature lower than the melting point of PTFE after the temperature not lower than the melting point is applied in the state where the expanded porous PTFE film is compressed between belts, the PTFE thin film can be manufactured while shrinkage is minimized. In addition, in the case of the belt press apparatus, since when the expanded porous PTFE film is held between belts, the air present in the interior of the film or between layers of the film is pushed out to the outside, occurrence of a void or a wrinkle to the aforementioned degree on the resulting PTFE thin film can be minimized. Moreover, since this belt press apparatus enables continuous production of a PTFE thin film, it can be preferably adopted.

Upon implementation of the first compressing step, in order to decrease voids in the PTFE thin film, it is also preferable to perform the compressing procedure by dividing into two or more stages.

In addition, in the second compressing step, when a hot press apparatus is used, heating compression may be performed by intervening a heat resistant film having a smooth surface between a hot press plate and a rolled film. Also when the belt press apparatus is used, heating compression may be performed by intervening the heat resistant film having the smooth surface between the belt and the film (expanded porous PTFE film or rolled film). As the heat resistant film, a polyimide film is preferable. According to this method, the surface roughness (Ra) of the PTFE thin film can be equivalent to the surface roughness (Ra) of the heat resistant film. Therefore, this is effective when a surface of a hot press plate of a hot press apparatus or a surface of a belt of a belt press apparatus can not be smoother.

For example, when the surface roughness (Ra) is made to be 0.1 μm or less by subjecting the heat press plate of the hot press apparatus used in the second compressing step to mirror finishing, surface roughness (Ra) of the PTFE thin film can be 0.1 μm or less without using the aforementioned heat resistant film. On the other hand, even in the case where surface roughness (Ra) of the hot press plate of the hot press apparatus is relatively large, when the aforementioned heat resistant film having surface roughness (Ra) of 0.01 μm or less is used, the surface roughness (Ra) of the PTFE thin film can be 0.01 μm or less.

If the surface roughness (Ra) of the PTFE thin film can be made to be 0.1 μm or less, the surface roughness (Ra) of the fluorine resin tubular article obtained by winding and laminating the PTFE thin film can be set to be the aforementioned preferable upper limit value or smaller. When the surface roughness (Ra) of the PTFE thin film exceeds the aforementioned upper limit value, the surface roughness (Ra) of the fluorine resin tubular article exceeds the aforementioned preferable upper limit value in some cases due to shrinkage of the thin film upon formation of the fluorine resin tubular article. In addition, when the fluorine resin tubular article obtained from the PTFE thin film having surface roughness (Ra) exceeding the aforementioned upper limit value is used in the superficial layer material of the fixing roll, the surface of the superficial material becomes rough due to the influence of a base elastic layer.

According to the aforementioned heat press method, the PTFE thin film (e.g. thickness: 20 μm or smaller) which was difficult to be obtained by a skiving method can be easily obtained. For example, by rolling the expanded porous PTFE film having a porosity of 80% and a thickness of 40 μm with a calendar roll (roll temperature: 70° C.) to a porosity of 2% and a thickness of 12 μm (first compressing step) and, thereafter, pressing it with a belt press apparatus under the conditions of a press plate temperature of 320 to 400° C., a pressure of 10.0 N/mm², a feeding rate of 0.5 to 2.0 m/min, and a press time of 0.5 to 10 min (second compressing step), the PTFE thin film having a porosity of 0% and a thickness of 10 μm can be obtained. In addition, by performing the processes as described above on an expanded porous PTFE film having a porosity of 85% and a thickness of 9 μm, a PTFE thin film having a porosity of 0% and a thickness of 2 μm can be obtained.

Further, in the heat press method, from one expanded porous PTFE film, a single PTFE thin film can be obtained, and additionally, a laminated PTFE thin film may also be obtained by laminating 2 to 100, preferably 2 to 20 expanded porous PTFE films.

It is recommended that a thickness of the thus obtained PTFE thin film is 0.1 μm or larger, preferably 0.5 μm or larger, further preferably 1 μm or larger and 10 μm or smaller, preferably 5 μm or smaller, more preferably 3 μm or smaller, further preferably 2 μm or smaller. In addition, this PTFE thin film has a specific gravity of 2.0 or more, and a void, pinhole or fibril structure is not observed by surface observation with a scanning electron microscope (magnification: 2000×). Further, this PTFE thin film is a transparent film having a uniform visual appearance, and a white opaque part or a white streak due to the presence of a void, pinhole or fibril structure is not observed.

By such procedures, a fluorine resin thin film such as the aforementioned PTFE thin film can be such that a tensile elastic modulus or a 5% tensile stress is within the aforementioned range in any plane direction. Measurements in all the plane directions are not necessary for the tensile elastic modulus and the 5% tensile stress. As a substitute procedure, the modulus or the stress can be confirmed by measuring in both directions of a direction parallel with the MD (hereinafter, simply referred to as “MD”) and a direction parallel with the TD (hereinafter, simply referred to as “TD”).

For manufacturing the fluorine resin tubular article of the present invention from the fluorine resin thin film such as the aforementioned PTFE thin film, the fluorine resin thin film is wound and laminated. Adhesion of respective layers at winding-lamination may be a heat adhering method, or a method of performing adhesion via an adhesive layer.

In the case of the heat adhering method, for example, a metal cylinder (e.g. SUS) is used as a core metal, the fluorine resin thin film is wound around the core metal prescribed times, and then heat-baking is performed at a temperature of not lower than the melting point of a fluorine resin to heat-adhere the wound and laminated respective layers. Thereafter, by removing the core metal, the fluorine resin tubular article can be obtained.

In the method of performing adhesion via the adhesive layer, the fluorine resin thin film with one side coated with adhesive is wound around the core metal prescribed times with the adhesive coated surface side being the inner side to adhere wound and laminated respective layers, by, if necessary, heat. Thereafter, by removing the core metal, the fluorine resin tubular article can be obtained.

In the fluorine resin tubular article obtained by using such procedures, there is no inclusion of the air between respective layers, and the state where respective layers are completely adhered is realized. Adhesion strength thereof is such an extent that a cohesive failure of the fluorine resin thin film occurs on delaminating.

In addition, by subjecting one side or both sides of the fluorine resin thin film to the previously known surface treatment such as corona discharge treatment, chemical etching treatment, and excimer laser treatment in advance, a sufficient interlayer adhering strength can be obtained in a shorter heating time, and thermal deterioration of the fluorine resin tubular article can be minimized, in the case of thermal adhering method, or in the case where heating is performed in a method of adhesion via an adhesion layer. These treatments exert greater adherability improving effect when both sides of a fluorine resin thin film are subjected to those treatments. When a surface of the fluorine resin thin film is roughened, and surface roughness (Ra) of the fluorine resin tubular article is reduced by treating the outer surface of the fluorine resin thin film, it is recommended to treat only an adhering portion of the inner surface of the fluorine resin thin film.

In addition, in order to enhance peelability between the core metal and the fluorine resin tubular article, it is also preferable to roughen the surface of the core metal by sand-blast process and the like.

A winding method is not particularly limited as far as it is a method which can laminate the fluorine resin thin film in a tube manner, but examples include a method of winding into a sushi roll, and a method of winding an obi-like fluorine resin thin film spirally.

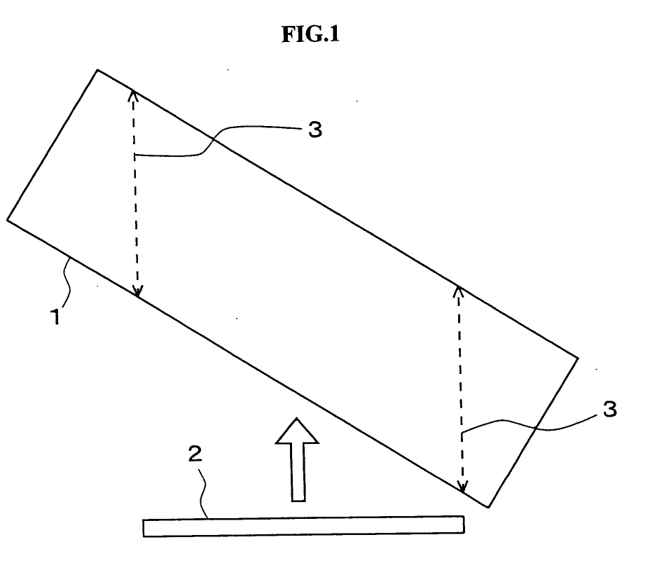

A method of winding an obi-like fluorine resin thin film spirally will be explained using FIG. 1. In FIG. 1, “1 ” represents the obi-like fluorine resin thin film, and “2 ” represents the core metal (core bar). And, “3 ” denotes a length of winding around the core metal. A value obtained by dividing this winding length “3 ” by the outer diameter of the core metal “2 ” is the number of winding times.

As shown in FIG. 1, the obi-like fluorine resin thin film 1 is placed under the state where the film is inclined relative to the core metal “2 ” and, in this state, by winding the obi-like fluorine resin thin film “1 ” around the core metal “2 ”, the tubular article which is formed of spiral winding of the fluorine resin thin film can be obtained.

In addition, a plurality of fluorine resin thin films may be sequentially wound. For example, after the first fluorine resin thin film is wound around the core metal one or more times, the second fluorine resin thin film may be wound around this fluorine resin thin film one or more times to form the fluorine resin tubular article.

In addition, in the fluorine resin tubular article of the present invention, since winding-lamination of the fluorine resin thin film causes the end part of the fluorine resin thin film to be present on an outer surface of the tubular article, the end part of the thin film generates a step. In addition, when a position of a winding-beginning end (tip end part) of the fluorine resin thin film and a position of a winding-ending end part (terminal end part) are not the same position in a circumferential direction of the tubular article, a difference is generated in a thickness of the tubular article with a thin film end part forming boundary.

For example, when the fluorine resin thin film is wound in the winding number of “n to n+1” (n is an integer of 1 or more), a region where a wall thickness of the tubular article corresponds to n layers (thin wall part) and a region where a wall thickness of the tubular article corresponds to n+1 layers (thick wall part) are formed, with an end part of the fluorine resin thin film forming boundary on a most superficial surface of the tubular article. By completely matching positions of the tip end part and the terminal end part of the fluorine resin thin film in the tubular article circumferential direction, such a difference in the thickness of a tubular article can be eliminated, but since unevenness can occur in actual production, position misalignment between the tip end part and the terminal end part of the fluorine resin thin film occurs, and then the aforementioned thickness difference occurs.

According to the study by the present inventors, when the aforementioned thickness difference is great, in the image fixing apparatus having the fixing roll or the fixing belt using the fluorine resin tubular article in the superficial layer material, it has been found out that the difference in the surface temperature becomes great between the part corresponding to the thin wall part and the thick wall part of the tubular article at an image fixing process, and a color difference or a luster difference occurs in a printed image to such an extent that it can be confirmed visually.

Therefore, in the present invention, by adopting the number of winding a fluorine resin thin film of 2 or more, preferably 3 or more, the aforementioned thickness difference in a fluorine resin tubular article is reduced. In this case, the difference in the surface temperature can be reduced between the part corresponding to the thin wall part and the part corresponding to the thick wall part, and the color difference and the luster difference in the printed image can be minimized to such an extent that they cannot be confirmed visually. An upper limit of the number of winding the fluorine resin thin film is not particularly limited, but for example, 100 times is preferable, a more preferable upper limit is 30 times, and a further preferable upper limit is 20 times.

In addition, also due to the step on the surface of the fluorine resin tubular article formed at the fluorine resin thin film end part, a line-like trace occurs on the printed image in some cases. In order to minimize the occurrence of this line-like trace, it is effective to use the fluorine resin thin film having a small thickness in manufacturing the fluorine resin tubular article. For example, when the fluorine resin thin film having a thickness of 20 μm or smaller, further 15 μm or smaller, particularly 10 μm or smaller is used, the line-like trace occurred on the printed image can be considerably decreased. For example, when the fluorine resin thin film having a thickness of 2 μm or smaller is used, a line-like trace on the printed image can be hardly observed visually.

In addition, even when the thickness of the fluorine resin thin film is small, by increasing the winding number to enhance the wall thickness of the tubular article to some extent, a life of the fixing member (fixing roll or fixing belt) can be secured. For example, the PTFE tubular article (wall thickness: about 18 to 24 μm) having the PTFE thin film thickness of 6 μm and the winding number of 3.5, and the PTFE tubular article (wall thickness: about 20.4 to 22.1 μm) having the PTFE thin film thickness of 1.7 μm and the winding number of 12.5 have almost equivalent durability. However, the smaller number of winding the fluorine resin thin film is advantageous in respect of the manufacturing cost. Like this, in the fluorine resin tubular article of the present invention, upon determination of the wall thickness thereof, the thickness and the number of winding a fluorine resin thin film can be arbitrarily combined.

The fluorine resin tubular article of the present invention has an excellent tensile strength. Specifically the tensile strength thereof is usually 80 N/mm² or greater, more preferably 100 N/mm² or more in both circumferential and tubular axial directions. In addition, the fluorine resin tubular article of the present invention also has an excellent light transmittance and, for example, the transmittance measured with a spectrophotometer (e.g. “UV-240” manufactured by SHIMADZU Corporation) for light having a wave length of 500 nm is preferably 35 to 95%. When the light transmittance is too low, the fluorine resin thin film contains voids in some cases and, in this case, since the heat conductivity unevenness can occur at image fixation due to the presence of the void, unevenness of toner melting is caused in some cases. In addition, when the light transmittance is too low, surface roughness (Ra) of the tubular surface exceeds the aforementioned upper limit value, due to the void or the wrinkle on the surface, in some cases. In this case, unevenness in releasability of the toner, or pressing the toner on the paper occurs in some cases, and there is a possibility that deterioration in image quality is caused.

In view of use of the fixing roll or the fixing belt as the superficial material, it is preferable that the inner surface of the fluorine resin tubular article is surface-treated for improving adherability. Examples of such a surface treatment include the previously known corona discharge treatment, chemical etching treatment and excimer laser treatment. For example, the inner surface of fluorine resin tubular article is subjected to chemical etching using tetra H (manufactured by JUNKOSHA Inc.) and, thereafter, the fluorine resin tubular article can be used in the superficial layer of the fixing roll or the fixing belt according to the conventional method. In this case, coloring or a fine cracking occurs in some cases on the chemically-etched surface, but the coloring and the cracking are not a problem when used as the superficial layer of the fixing roll or the fixing belt.

As a direction of attaching the fluorine resin tubular article relative to a rotation direction of the fixing roll, there are two kinds of directions: a direction into which a nip part is introduced in an order from the thick wall part to the thin wall part, and a direction into which a nip part is introduced in an order of from the thin wall part to the thick wall part. When a seam line trace occurs on the printed image, or a color difference or a luster difference corresponding to the thin wall part and the thick wall part of the fixing roll superficial layer occurs, a priority is approximately the same in either direction, but from a view point of advantage on peeling of the superficial layer, the direction of introduction into the nip part in the order of from the thick wall part to the thin wall part is preferable.

Since the fluorine resin tubular article of the present invention satisfies the prescribed tensile elastic modulus and/or the prescribed 5% tensile stress regardless of the thickness not greater than the prescribed thickness, the fluorine resin tubular article excellent in durability can be provided, which can highly minimize superficial layer wrinkle and superficial layer deformation, and occurrence of superficial layer breakage, when used as the superficial layer material of the fixing roll or the fixing belt of the image fixing apparatus which can attain high image quality and reduction in consumed electric power.

### EXAMPLES

The present invention will be described in more detail below based on Examples. However, the following Examples do not limit the present invention, and implementation in a range not departing the range described above and below is all included in the technical scope of the present invention.

### Manufacturing Example 1

### Manufacturing of Fluorine Resin Thin Film

### Manufacturing Example 1-1

According to a conventional method, an unbaked tape having a thickness of 0.2 mm and a width of 150 mm was manufactured from a PTFE fine powder (“FLUON CD123” manufactured by ASAHI GLASS Co., LTD.). That is, procedures of mixing a molding aid into the PTFE fine powder to obtain a paste, extruding and roll-rolling the paste, and removing the molding aid by drying was adopted.

This unbaked tape was first expanded 20-fold (1900%) in the MD using a biaxial expanding machine under the condition of a expanding temperature of 300° C. and a expanding rate of 50%/sec, and was then expanded 26-fold (2500%) in the TD. Then, in the state where four sides were fixed, baking was performed at 375° C. for 15 minutes to obtain an expanded porous PTFE film (porosity: 80%, thickness: 7.5 μm).

The expanded porous PTFE film was compressed using a calendar roll apparatus under the condition of a roll temperature of 70° C., a linear pressure of 8 N/mm² and a feeding rate of 6.0 m/min (first compressing step) to obtain a white cloudy rolled film having a porosity of 2% and a thickness of 1.7 μm. This rolled film was held between two polyimide films (“UPILEX 20S” manufactured by UBE INDUSTRIES LTD.), and this was thermally pressed with a hot press apparatus for 5 minutes under the condition of a press plate temperature of 400° C. and a surface pressure of 10 N/mm² and, thereafter, cooled to a room temperature over 60 minutes while maintaining the surface pressure (second compressing step) to obtain a PTFE thin film. The structure and properties of the resulting PTFE thin film are shown in Table 1.

### Manufacturing Example 1-2

According to the same manner as that of Manufacturing Example 1-1 except that a expanding ratio upon manufacturing of an expanded porous PTFE thin film was changed to 10-fold (900%) in the MD and 15-fold (1400%) in the TD, a PTFE thin film was manufactured. The structure and properties of the resulting PTFE thin film are shown in Table 1.

### Manufacturing Example 1-3

An unbaked tape having a thickness of 0.1 mm and a width of 150 mm was manufactured from a PTFE fine powder (“FLUON CD123” manufactured by ASAHI GLASS Co., LTD.) as in Manufacturing Example 1-1. This unbaked tape was expanded first 15-fold (1400%) in the MD and, then, 15-fold (1400%) in the TD using a biaxial expanding machine under the condition of a expanding temperature of 300° C. and a expanding rate of 20%/sec. Then, in the state where four sides were fixed, baking was performed at 360° C. for 5 minutes to obtain an expanded porous PTFE film. Using the resulting expanded porous PTFE film, a PTFE thin film was obtained as in Manufacturing Example 1-1. The structure and properties of the resulting PTFE thin film are shown in Table 1.

### Manufacturing Example 1-4

An unbaked tape obtained as in Manufacturing Example 1-1 was first expanded 14-fold (1300%) in the MD and, then expanded 35-fold (3400%) in the TD using a biaxial expanding machine under the condition of a expanding temperature of 300° C. and a expanding rate of 50%/sec. Then, in the state where four sides are fixed, baking was performed at 360° C. for 5 minutes to obtain an expanded porous PTFE film. Using the resulting expanded porous PTFE film, a PTFE thin film was obtained as in Manufacturing Example 1-1. The structure and properties of the resulting PTFE thin film are shown in Table 1.

TABLE 1

| | | | Properties of PTFE Thin Film | | | | | | | | |
|---|---|---|---|---|---|---|---|---|---|---|---|
| | Structure of PTFE | | Tensile Elastic Modulus | | | 5% Tensile Stress | | | Tensile Strength | | |
| | Thin Film | | (N/mm²) | | | (N/mm²) | | | (N/mm²) | | |
| Manufacturing | Porosity | Thickness | | | Inclined | | | Inclined | | | Inclined |
| Example | (%) | (μm) | MD | TD | Direction | MD | TD | Direction | MD | TD | Direction |
| 1-1 | 0 | 1.5 | 2200 | 1450 | 1650 | 120 | 60 | 85 | 660 | 400 | 480 |
| 1-2 | 0 | 5.0 | 1430 | 700 | 830 | 60 | 20 | 35 | 210 | 140 | 170 |
| 1-3 | 0 | 1.4 | 400 | 490 | 430 | 13 | 15 | 13 | 200 | 230 | 210 |
| 1-4 | 0 | 1.5 | 450 | 2800 | 1200 | 18 | 125 | 60 | 180 | 390 | 245 |

In Table 1, “inclined direction” means a direction which is +45° relative to the MD.

### Manufacturing Example 2

### Manufacturing of Fluorine Resin Tubular Article

### Manufacturing Example 2-1

One side of the PTFE thin film obtained in Manufacturing Example 1-1 was subjected to corona discharge treatment (condition: 50 W/m·min). Thereafter, this PTFE thin film was wound around a core metal (cylinder made of SUS304, outer diameter: 26.2 mm, width: 500 mm). Winding was performed in a sushi roll manner by 6.1 wraps [the state where the film is wound six times (6) layers and, further, 0.1-fold of the circumferential length from the PTFE thin film end part on a most superficial surface forms a seventh layer] so that a corona discharge-treated surface of the PTFE thin film was on an inner side, and the MD was a circumferential direction of a core metal. Thereafter, a film end part in a cylinder axial direction of the core metal was fixed with ring-like stoppers. This was placed into an oven at 400° C., and baked for 30 minutes and, after cooling, the stoppers were detached, and the core metal was drawn to obtain a fluorine resin tubular article having a maximum wall thickness of 10.5 μm (thickness of seven layers: 10.5 μm, thickness of six layers: 9.0 μm) and an inner diameter of 26.3 mm. The structure and properties of the resulting fluorine resin tubular article are shown in Table 2.

### Manufacturing Example 2-2

According to the same manner as that of Manufacturing Example 2-1 except that winding was performed so that the TD of the PTFE thin film was a circumferential direction of the core metal, a fluorine resin tubular article having a maximum wall thickness of 10.5 μm (thickness of seven layers: 10.5 μm, thickness of six layers: 9.0 μm) and an inner diameter of 26.3 mm was obtained. The structure and properties of the resulting fluorine resin tubular article are shown in Table 2.

### Manufacturing Example 2-3

According to the same manner as that of Manufacturing Example 2-1 except that the PTFE thin film obtained in Manufacturing Example 1-2 was used, and winding around the core metal after the corona discharge treatment was performed by 2.1 wraps, a fluorine resin tubular article having a maximum wall thickness of 15.0 μm (thickness of three layers: 15.0 μm, thickness of two layers: 10.0 μm) and an inner diameter of 26.3 mm was obtained. The structure and properties of the resulting fluorine resin tubular article are shown in Table 2.

### Manufacturing Example 2-4

According to the same manner as that of Manufacturing Example 2-3 except that the TD of the PTFE thin film was a circumferential direction of a core metal, a fluorine resin tubular article having a maximum wall thickness of 15.0 μm (thickness of three layers: 15.0 μm, thickness of two layers: 10.0 μm) and an inner diameter of 26.3 mm was obtained. The structure and properties of the resulting fluorine resin tubular article are shown in Table 2.

### Manufacturing Example 2-5

According to the same manner as that of Manufacturing Example 2-3 except that winding the PTFE thin film after corona discharge treatment around a core metal was performed by 1.5 wraps, a fluorine resin tubular article having a maximum wall thickness of 10.0 μm (thickness of two layers: 10.0 μm, thickness of one layer: 5.0 μm) and an inner diameter of 26.3 mm was obtained. The structure and properties of the resulting fluorine resin tubular article are shown in Table 2.

### Manufacturing Example 2-6

According to the same manner as that of Manufacturing Example 2-1 except that the PTFE thin film was wound around a core metal (cylinder made of SUS304, outer diameter: 30.7 mm, width: 500 mm), a fluorine resin tubular article having a maximum wall thickness of 10.5 μm (thickness of seven layers: 10.5 μm, thickness of six layers: 9.0 μm), and an inner diameter of 30.8 mm was obtained. The structure and properties of the resulting fluorine resin tubular article are shown in Table 2.

### Manufacturing Example 2-7

According to the same manner as that of Manufacturing Example 2-1 except that the PTFE thin film obtained in Manufacturing Example 1-3 was used, a fluorine resin tubular article having a maximum wall thickness of 9.8 μm (thickness of seven layers: 9.8 μm, thickness of six layers: 8.4 μm) and an inner diameter of 26.3 mm was obtained. The structure and properties of the resulting fluorine resin tubular article are shown in Table 2.

### Manufacturing Example 2-8

According to the same manner as that of Manufacturing Example 2-2 except that the PTFE thin film obtained in Manufacturing Example 1-3 was used, a fluorine resin tubular article having a maximum wall thickness of 9.8 μm (thickness of seven layers: 9.8 μm, thickness of six layers: 8.4 μm) and an inner diameter of 26.3 mm was obtained. The structure and properties of the resulting fluorine resin tubular article are shown in Table 2.

### Manufacturing Example 2-9

According to the same manner as that of Manufacturing Example 2-1 except that the PTFE thin film obtained in Manufacturing Example 1-4 was used, a fluorine resin tubular article having a maximum wall thickness of 10.5 μm (thickness of seven layers: 10.5 μm, thickness of six layers: 9.0 μm) and an inner diameter of 26.3 mm was obtained. The structure and properties of the resulting fluorine resin tubular article are shown in Table 2.

### Manufacturing Example 2-10

According to the same manner as that of Manufacturing Example 2-2 except that the PTFE thin film obtained in Manufacturing Example 1-4 was used, a fluorine resin tubular article having a maximum wall thickness of 10.5 μm (thickness of seven layers: 10.5 μm, thickness of six layers: 9.0 μm) and an inner diameter of 26.3 mm was obtained. The structure and properties of the resulting fluorine resin tubular article are shown in Table 2.

### Manufacturing Example 2-11

According to the same manner as that of Manufacturing Example 2-6 except that the PTFE thin film obtained in Manufacturing Example 1-3 was used, a fluorine resin tubular article having a maximum wall thickness of 9.8 μm (thickness of seven layers: 9.8 μm, thickness of six layers: 8.4 μm) and an inner diameter of 30.8 mm was obtained. The structure and properties of the resulting fluorine resin tubular article are shown in Table 2.

TABLE 2

| | Structure of | | | | | | | |
|---|---|---|---|---|---|---|---|---|
| | Fluorine Resin | | | | | | | |
| | Tubular Article | | Properties of Fluorine Resin Tubular Article | | | | | |
| | | Maximum | Tensile Elastic Modulus | | 5% Tensile Stress | | Tensile Strength | |
| | | Wall | (N/mm²) | | (N/mm²) | | (N/mm²) | |
| Manufacturing | Porosity | Thickness | Circumferential | Axial | Circumferential | Axial | Circumferential | Axial |
| Example | (%) | (μm) | Direction | Direction | Direction | Direction | Direction | Direction |
| 2-1 | 0 | 10.5 | 2000 | 1740 | 100 | 50 | 400 | 380 |
| 2-2 | 0 | 10.5 | 1680 | 1990 | 50 | 90 | 360 | 390 |
| 2-3 | 0 | 15.0 | 1300 | 900 | 55 | 15 | 130 | 80 |
| 2-4 | 0 | 15.0 | 900 | 1220 | 15 | 50 | 90 | 120 |
| 2-5 | 0 | 10.0 | 1200 | 900 | 50 | 15 | 110 | 80 |
| 2-6 | 0 | 10.5 | 2000 | 1740 | 100 | 50 | 400 | 380 |
| 2-7 | 0 | 9.8 | 500 | 650 | 10 | 10 | 100 | 110 |
| 2-8 | 0 | 9.8 | 550 | 500 | 11 | 10 | 130 | 110 |
| 2-9 | 0 | 10.5 | 650 | 3600 | 13 | 100 | 80 | 250 |
| 2-10 | 0 | 10.5 | 3400 | 600 | 90 | 13 | 220 | 100 |
| 2-11 | 0 | 9.8 | 500 | 650 | 10 | 10 | 100 | 110 |

In Table 2, the “circumferential direction” and the “axial direction” mean a circumferential direction and an axial direction of a fluorine resin tubular article, respectively.

### Manufacturing Example 3

### Manufacturing of Fixing Roll

### Manufacturing Example 3-1

One side end part of the fluorine resin tubular article obtained in Manufacturing Example 2-1 was closed with a clip, a Na/naphthalene complex salt solution (“Tetra H” manufactured by JUNKOSHA INC.) at 25° C. was poured into the interior thereof, and was held for 10 seconds, and the solution was discharged from the tubular article. Subsequently, a procedure of pouring sequentially methanol, water and methanol into the fluorine resin tubular article as in the case of the Na/naphthalene complex salt solution, holding each for 10 seconds, and discharging this was performed. Thereafter, the air was blown to an inner and outer surfaces of this fluorine resin tubular article to dry the article.

A primer (“DY39-051” manufactured by DOW CORNING TORAY Co., LTD.) was coated on an inner surface of the fluorine resin tubular article after drying, and the article was attached to an inner wall of a mold for roll molding having an inner diameter of 26.7 mm. Further, an aluminum axial core (outer diameter: 25.5 mm, shank length: 410 mm) was disposed at a center in the interior of the fluorine resin tubular article, a silicone rubber (“KE-1356” manufactured by SHIN-ETSU CHEMICAL Co., LTD.) was poured between the fluorine resin tubular article and the aluminum axial core, and this was thermally cured at 130° C. for 30 minutes and, further, secondarily cured at 200° C. for 4 hours to obtain a fixing roll having the fluorine resin tubular article in a superficial layer.

Manufacturing Examples 3-2 to 3-9

According to the same manner as that of Manufacturing Example 3-1 except that each of the fluorine resin tubular articles shown in Table 3 was used, a fixing roll having the fluorine resin tubular article in a superficial layer was obtained.

TABLE 3

| Fixing Roll | Fluorine Resin Tubular Article Used |
|---|---|
| Manufacturing Example 3-1 | Manufacturing Example 2-1 |
| Manufacturing Example 3-2 | Manufacturing Example 2-2 |
| Manufacturing Example 3-3 | Manufacturing Example 2-3 |
| Manufacturing Example 3-4 | Manufacturing Example 2-4 |
| Manufacturing Example 3-5 | Manufacturing Example 2-5 |
| Manufacturing Example 3-6 | Manufacturing Example 2-7 |
| Manufacturing Example 3-7 | Manufacturing Example 2-8 |
| Manufacturing Example 3-8 | Manufacturing Example 2-9 |
| Manufacturing Example 3-9 | Manufacturing Example 2-10 |

<Assessment>

Each of the fixing rolls obtained in Manufacturing Examples 3-1 to 3-9 was mounted on a color printer “DocuPrint C2220” manufactured by FUJI XEROX Co., LTD., paper passage assessment was performed, and occurrence of a wrinkle on a fixing roll superficial layer accompanied with paper passage, and influence of the wrinkle trace on the printed image were investigated. Evaluation standards of results of paper passage assessment are shown in Table 4, and assessment results are shown in Table 5.

TABLE 4

| Evaluation | |
|---|---|
| standards | Results of Paper Passage Assessment |
| 1 | No wrinkle |
| 2a | Occurrence of wrinkle in fixing roll axial direction |
| | Occurrence of wrinkle in fixing roll circumferential |
| 2b | direction |
| 3a | Occurrence of more severe wrinkle in fixing roll axial |
| | direction |
| 3b | Occurrence of more severe wrinkle in fixing roll |
| | circumferential direction |
| 4 | Occurrence of more severe wrinkle in fixing roll axial |
| | direction/occurrence of wrinkle in circumferential direction |
| 5 | Occurrence of more severe wrinkle in axial direction and |
| | circumferential direction of fixing roll |

TABLE 5

| | Paper Passage | Superficial Layer State | | | | | | | | Paper Passage Number at Occurrence |
|---|---|---|---|---|---|---|---|---|---|---|
| | Number | 0 | 5000 | 10000 | 20000 | 40000 | 50000 | 80000 | 100000 | of Wrinkle Trace on Printed Image |
| Fixing Roll | Manufacturing | 1 | 1 | 1 | 1 | 1 | 1 | 1 | 1 | No occurrence |
| | Example 3-1 | | | | | | | | | |
| | Manufacturing | 1 | 1 | 1 | 1 | 1 | 1 | 1 | 1 | No occurrence |
| | Example 3-2 | | | | | | | | | |
| | Manufacturing | 1 | 1 | 1 | 1 | 1 | 1 | 1 | 1 | No occurrence |
| | Example 3-3 | | | | | | | | | |
| | Manufacturing | 1 | 1 | 1 | 1 | 1 | 1 | 1 | 1 | No occurrence |
| | Example 3-4 | | | | | | | | | |
| | Manufacturing | 1 | 1 | 1 | 1 | 1 | 1 | 1 | 2b | No occurrence |
| | Example 3-5 | | | | | | | | | |
| | Manufacturing | 1 | 2a | 2a | 2a | 2a | 4 | 5 | 5 | Wrinkle trace in axial direction: 7500 |
| | Example 3-6 | | | | | | | | | Wrinkle trace in circumferential direction: 65000 |
| | Manufacturing | 1 | 2a | 3a | 3a | 3a | 4 | 5 | 5 | Wrinkle trace in axial direction: 7500 |
| | Example 3-7 | | | | | | | | | Wrinkle trace in circumferential direction: 70000 |
| | Manufacturing | 1 | 2a | 3a | 3a | 3a | 3a | 3a | 3a | Wrinkle trace in axial direction: 6000 |
| | Example 3-8 | | | | | | | | | |
| | Manufacturing | 1 | 1 | 1 | 1 | 1 | 2b | 3b | 3b | Wrinkle trace in circumferential direction: 65000 |
| | Example 3-9 | | | | | | | | | |

In the fixing roll (Manufacturing Examples 3-1 to 3-5) using the fluorine resin tubular article (Manufacturing Examples 2-1 to 2-5) having suitable values of a tensile elastic modulus and a 5% tensile stress in both a circumferential direction and an axial direction in a superficial layer material, even at a stage where the number of sheets of passed paper was very high, the state of a superficial layer is good, and adverse influence on a printed image is minimized, demonstrating that the roll has such durability that the roll can endure the use for a long period of time. To the contrary, in the fixing roll (Manufacturing Examples 3-6 to 3-9) using the fluorine resin tubular article (Manufacturing Examples 2-7 to 2-10) not exhibiting preferable values of a tensile elastic modulus and a 5% tensile stress in a circumferential direction and/or an axial direction in a superficial layer material, the state of a superficial layer is deteriorated at a stage where the number of sheets of passed paper was relatively small.

In addition, the presence or the absence of unevenness of luster in a printed image when a fixing roll of Manufacturing Example 3-3 and a fixing roll of Manufacturing Example 3-5 were used were investigated, and influence of a difference in thicknesses of wall thicknesses of fluorine resin tubular articles (Manufacturing Examples 2-3 and 2-5) used in them was investigated. As a result, in a printed image obtained using the fixing roll of Manufacturing Example 3-5, since the winding number of a fluorine resin thin film in the raw material fluorine resin tubular article (Manufacturing Example 2-5) of this fixing roll is less than 2 times, a thickness of a thickest part is about 2-fold that at a thinnest part in this tubular article, and unevenness of luster derived therefrom arisen. To the contrary, in a printed image obtained using the fixing roll of Manufacturing Example 3-3, since the winding number of a fluorine resin thin film in the raw material fluorine resin tubular article (Manufacturing Example 2-3) of this fixing roll is 2 times or more, and a difference in a thickness in this tubular article is small, the aforementioned unevenness of luster did not occur.

### Manufacturing Example 4

### Manufacturing of Fixing Belt

### Manufacturing Example 4-1

A polyimide varnish (“U varnish S” manufactured by UBE INDUSTRIES LTD.) was coated on an outer wall of a core metal (cylinder made of SUS304, outer diameter: 30.0 mm, width: 500 mm), this core metal was passed through a center of a die having an inner diameter of 31.0 mm, and an excess polyimide varnish was scraped off, to obtain a coated thin film of a polyimide varnish on a core metal. Then, after heating at 300° C. for 30 minutes, a core metal was taken out to obtain a polyimide tube having a thickness of 50 μm, an outer diameter of 30.0 mm and a length of 400 mm. An outer surface of the resulting polyimide tube was corona discharge-treated (condition: 100 W/m²·min), a primer (“DY39-012” manufactured by DOW CORNING TORAY Co. LTD.) was coated at a thickness of about 2 μm, and a core metal (cylinder made of SUS304, outer diameter: 29.9 mm, width: 500 mm) was inserted into a hollow of the polyimide tube.

The fluorine resin tubular article obtained in Manufacturing Example 2-6 was subjected to inner surface treatment and primer treatment as in Manufacturing Example 3-1, and was attached to an inner wall of a mold for roll molding (SUS304, inner diameter: 31.2 mm, width: 500 mm). The core metal covered with the aforementioned polyimide tube was inserted into a center of a hollow part in this mold for roll molding, and a silicone rubber (“KE-1356” manufactured by SHIN-ETSU CHEMICAL Co., LTD.) was injected between a fluorine resin tubular article and a polyimide tube. The silicon rubber was thermally cured at 130° C. for 30 minutes and, further, secondarily cured at 200° C. for 4 hours, and the mold for roll molding and the core metal were detached to obtain a fixing belt having a fluorine resin tubular article of a maximum wall thickness of 65 μm (polyimide layer, silicone rubber layer, fluorine resin layer), an outer diameter of 31.2 mm and a length of 343 mm in a superficial layer.

### Manufacturing Example 4-2

According to the same manner as that of Manufacturing Example 4-1 except that the tube obtaied in Manufacturing Example 2-11 was used, a fixing belt having a fluorine resin tubular article of a maximum wall thickness of 65 μm (polyimide layer, silicone rubber layer, fluorine resin layer), with an outer diameter of 31.2 mm and a length of 343 mm in a superficial layer was obtained.

<Assessment>

A fixing unit of a color printer “DocuPrint C2220” manufactured by FUJI XEROX Co., LTD. was removed and fixed on a pedestal, thereby, a bench assessing machine was manufactured, in which a gear attached to a fixing roll shaft and a gear attached to an axis of an external motor are meshed to transmit driving of a motor to a fixing roll, and a fixing roll and a fixing belt of the fixing unit can be rotation-driven in the nipped state. Each of the belts obtained in Manufacturing Examples 4-1 and 4-2 was mounted on this bench assessing machine, and rotation driving at 48 rpm (fixing roll standard) was continuously applied and, thereupon, occurrence of a wrinkle on a fixing roll superficial layer, and influence of the wrinkle trace on a printed image were investigated. Evaluation standards of results of continuous driving assessment are shown in Table 6, and assessment results are shown in Table 7.

TABLE 6

| Evaluation | |
|---|---|
| standards | Results of Paper Passage Assessment |
| 1 | No Wrinkle |
| 2a | Occurrence of wrinkle in fixing belt axial direction |
| 3a | Occurrence of more severe wrinkle in fixing belt axial |
| | direction |

TABLE 7

| | Driving Time | Superficial Layer State | | | | | | Driving Time at Occurrence of Wrinkle |
|---|---|---|---|---|---|---|---|---|
| | (h) | 0 | 1 | 5 | 10 | 24 | 48 | Trace on Printed Image |
| Fixing Roll | Manufacturing | 1 | 1 | 1 | 1 | 1 | 1 | No occurrence |
| | Example 4-1 | | | | | | | |
| | Manufacturing | 1 | 2a | 3a | 3a | 3a | 3a | No occurrence |
| | Example 4-2 | | | | | | | |

In the fixing belt (Manufacturing Example 4-1) using the fluorine resin tubular article (Manufacturing Example 2-6) having preferable values of a tensile elastic modulus and a 5% tensile stress in both of a circumferential direction and an axial direction in a superficial layer material, even at a stage of a very long driving time, the state of a superficial layer is good, demonstrating that the belt has such the durability that the belt can endure use for a long period of time. To the contrary, in the fixing roll (Manufacturing Example 4-2) using the fluorine resin tubular article (Manufacturing Example 2-11) not exhibiting preferable values of a tensile elastic modulus and a 5% tensile stress in a circumferential direction and an axial direction in a superficial material, the state of a superficial layer is deteriorated at a stage of a relatively short driving time.

### INDUSTRIAL APPLICABILITY

Since the fluorine resin tubular article of the present invention can highly minimize the occurrence of superficial layer wrinkle, superficial layer deformation, superficial layer breakage of a fluorine resin tubular article, it can be advantageously used in various image fixing apparatuses (particularly, image fixing apparatus requiring high image quality and reduction in consumed electric power), or a fixing roll and a fixing belt adopted in this image fixing apparatus.

1. A fluorine resin tubular article comprising a polytetrafluoroethylene-based fluorine resin as a constitutional element, wherein the tubular article has a maximum wall thickness of 20 μm or less, and satisfies following (1) and/or (2) properties:
(1) tensile elastic moduli in a circumferential direction and a tube axial direction are both 900 N/mm² or greater; and
(2) tensile stresses at 5% elongation in a circumferential direction and a tube axial direction are both 15 N/mm² or greater.

2. The fluorine resin tubular article according to claim 1, wherein the fluorine resin tubular article having both tensile elastic moduli in a circumferential direction and a tube axial direction of 900 N/mm² or greater, is formed by winding and laminating a fluorine resin thin film having a tensile elastic modulus of 500 N/mm² or greater in any plane direction two or more times.

3. The fluorine resin tubular article according to claim 1, wherein the fluorine resin tubular article having both tensile stresses at 5% elongation in a circumferential direction and a tube axial direction of 15 N/mm² or greater, is formed by winding and laminating a fluorine resin thin film having a tensile stress at 5% elongation of 20 N/mm² or greater in any plane direction two or more times.

4. The fluorine resin tubular article according t claim 1, wherein the tubular article has surface roughness (Ra) of 0.5 μm or less.

5. The fluorine resin tubular article according to claim 1, wherein the tubular article is such that an inner surface is surface-treated for improving adherability.

6. A fixing roll, characterized in that the fixing roll has the fluorine resin tubular article as defined in claim 1 in a superficial layer.

7. A fixing belt, characterized in that the fixing belt has the fluorine resin tubular article as defined in claim 1 in a superficial layer.

8. An image fixing apparatus, characterized in that the image fixing apparatus has the fixing roll as defined in claim 6.

9. An image fixing apparatus, characterized in that the image fixing apparatus has the fixing belt as defined in claim 7.
